(19) United States
(12) Patent Application Publication
(10) Pub. No.: US 2013/0319572 A1
(43) Pub. Date: Dec. 5, 2013

(54) FUEL ADDITIVE BOTTLE FOR A CAPLESS FUEL SYSTEM

(71) Applicant: ALPHA CONSOLIDATED HOLDINGS INC., St. Louis, MO (US)

(72) Inventor: James A. Zweifel, Seville, OH (US)

(73) Assignee: ALPHA CONSOLIDATED HOLDINGS INC., St. Louis, MO (US)

(21) Appl. No.: 13/841,317

(22) Filed: Mar. 15, 2013

Related U.S. Application Data
(60) Provisional application No. 61/652,476, filed on May 29, 2012.

(51) Int. Cl. B67D 7/42

(52) U.S. Cl. CPC B67D 7/42
USPC 141/1; 141/350

(57) ABSTRACT

The present disclosure relates to a container having a fuel additive, and a spout extending from and in fluid communication with the container. The spout includes an elongated engagement nozzle having a radially outer surface extending to a distal tip of the bottle. The elongated engagement nozzle defines an opening for discharging the fluid from the bottle and has an axial length and radial diameter dimensioned for insertion into the throat of a capless fuel system sufficiently far to contact and operate a lock disengagement element within the throat and to open an internal closure within the throat. A cap attachment portion is configured for attaching a cap to close the engagement nozzle opening, and is disposed clear of the engagement nozzle outer surface.

### CROSS-REFERENCE TO RELATED APPLICATION

This application relates to and claims priority from U.S. Patent Application No. 61/652,476, filed on May 29, 2012, the entire disclosure of which is incorporated herein by reference.

### FIELD

The present disclosure generally relates to methods and devices for adding a fuel additive to a capless fuel system. More particularly, the present disclosure relates to a fuel additive bottle configured to engage a capless fuel system to disengage the capless fuel system locking mechanism.

### BACKGROUND

In a traditional capped fuel tank system, a threaded cap is used to cap the tank. To add fuel or a fuel additive to the fuel tank, a user unscrews the cap from the fuel tank. Typically, the neck leading to the gas tank is unlocked or unobstructed once the cap is unscrewed. In recent years, capless fuel systems have been introduced, such as the Ford capless fuel system. In such systems, the tank filler neck is typically closed internally by a locked flap or door located within the throat of fuel tank filler neck. When the user inserts a gas nozzle into the capless fuel system, the gas nozzle disengages a locking mechanism, allowing the nozzle to push aside a door and add fuel.

Traditional fuel additive bottles, such as bottle 100 shown in FIG. 1, are composed of a container 105 that holds the additive, and a spout portion 110 from which the additive is poured. The spout has a short threaded area for screwing on a bottle cap and has a cross-section 115 that is generally sized approximately the same size as, or slightly smaller than, the size of the internal diameter of the filler neck of a capped fuel system. To add a fuel additive to a traditional capped fuel tank system, the user unscrews the cap from the fuel tank, unscrews the cap from the fuel additive bottle, and pours the fuel additive into the fuel tank. Traditional fuel additive bottles, however, are not compatible with capless fuel tank system that can require a locking mechanism to be disengaged from within the filler neck.

U.S. Patent Publication No. 2012/0285579 discloses a bottle that can be used with a capless fuel system. The bottle has threads 44 located at the end of neck 42. However, threads 44 can interfere with the unlocking mechanism of a capless fuel system.

What is desired, therefore, is a fuel additive container that can add fuel to a capless fuel tank system.

### SUMMARY

In an embodiment of a method for adding a liquid to a capless fuel system, a bottle is provided that can include a container holding the liquid, a spout, and a cap-attachment portion. The spout extends from and is in fluid communication with the container and has an elongated engagement nozzle with a radially outer surface extending to a distal tip of the bottle. The nozzle defines an opening for discharging the fluid from the bottle. The cap attachment portion can be configured for attaching a cap to close the engagement nozzle opening, and can be disposed clear of an outer surface of the engagement nozzle. In this exemplary method, the engagement nozzle can be inserted into a throat of a capless fuel system sufficiently far to contact and operate a lock disengagement element within the throat of the capless system to open an internal closure within the throat.

The cap attachment portion can be disposed on the bottle so as to remain clear of contact with the lock disengagement element as the elongated engagement nozzle is inserted into the throat. In some embodiments, the cap attachment portion is disposed proximally of the engagement nozzle, such as between the nozzle and the container, such that the engagement nozzle operates the lock disengagement element upon insertion of the engagement nozzle into the throat without the cap attachment portion reaching the lock disengagement element. In some exemplary embodiments, the outer surface of the engagement nozzle is substantially cylindrical, and in some exemplary embodiments, the outer surface of the engagement nozzle has a diameter of around 0.8 inches.

In an embodiment, the fuel system throat includes an outer mouth portion that tapers towards the lock disengagement element, and the attachment portion is inserted into the mouth when the engagement nozzle reaches and operates the lock disengagement element. In an embodiment, the cap attachment portion has male threads configured to engage female threads of a cap. In an embodiment, the elongated engagement nozzle is axially longer than the cap attachment portion. The cap attachment portion can be, for example, smaller than half the axial length of, and larger in outer diameter, than the engagement nozzle. In one embodiments, the cap attachment portion is disposed within the bottle to attach to a counterpart engagement portion of a cap. For example, the cap attachment portion can have female threads on an interior surface of the engagement nozzle configured to engage male threads of a cap.

The bottle can be provided with the cap attached to the cap attachment portion, thus closing the opening, and the method can include detaching the cap from the cap attachment portion to open the opening. In an embodiment, the unlocking member includes a tab that is depressed radially by the engagement nozzle inserted into the throat. The liquid can be dispensed from the bottle into the open capless fuel system.

The bottle can be of unitary construction, such as of polyethylene terephthalate or ABS. In an embodiment, the liquid is a fuel additive. Another embodiment of the present disclosure is a fuel additive bottle.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with paragraphs particularly pointing out and distinctly claiming the subject matter that is regarded as forming the present invention, it is believed that the disclosure will be better understood from the following description taken in conjunction with the accompanying figures, in which:

FIGS. 1A and 1B are a perspective and a partial front view of a prior art fuel additive bottle;

FIG. 2A and 2B are a perspective and a front view of a fuel additive bottle constructed in accordance with the present disclosure;

FIG. 2C is a cutaway view thereof with a cap;

FIGS. 3 and 4 show embodiments of a fuel additive bottle having an adapter;

FIGS. 5A and 5B show an exemplary method of using the bottle of FIGS. 2A-C with a capless fuel system; and

FIG. 6 depicts a flow chart illustrating steps in an example of adding a fuel additive to a capless fuel system.

### DETAILED DESCRIPTION

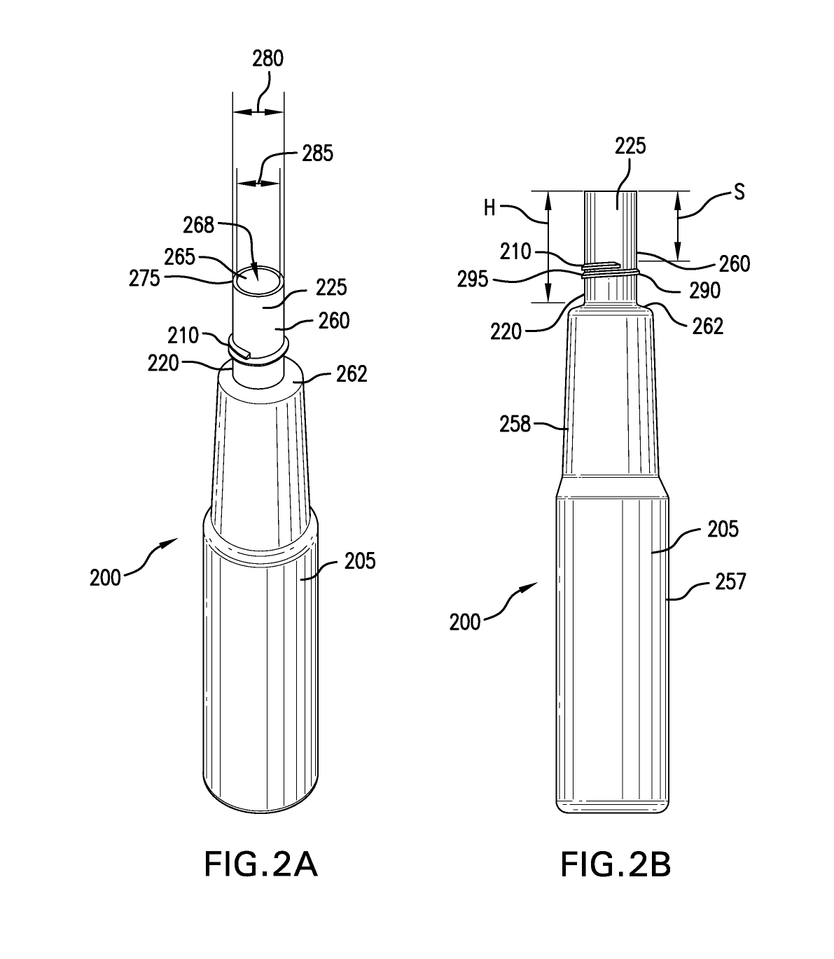

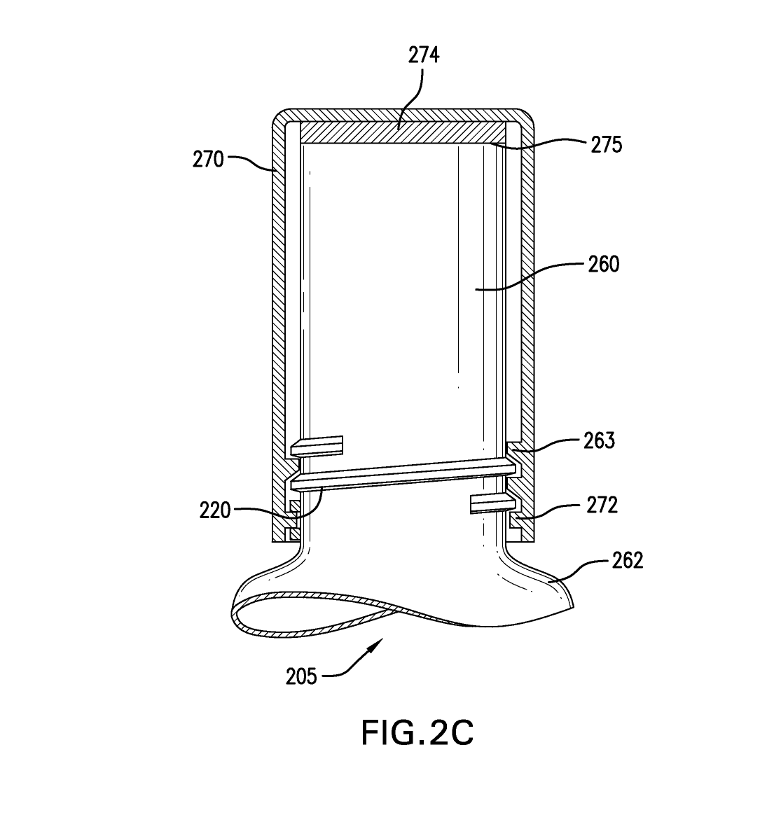

The present disclosure relates to a novel and advantageous fuel additive bottle that can be used in a capped and capless fuel system. In the embodiment of FIGS. 2A-C, bottle 200 (e.g., a fuel additive bottle) can include a container or body 205 that is configured to hold a liquid, and a neck portion providing a spout 260 extending from and in fluid communication with container 205. The bottle 200 and container 205 are preferably closed, except for via the spout 260, to retain and real the liquid therein until the spout 260 is opened.

The preferred spout includes an elongated engagement nozzle 225 with a radial outer surface extending towards and terminating at a distal tip 275 of fuel additive bottle 200. The nozzle 225 preferably defines a nozzle opening 265. A fluid conduit 268 fluidly connects the container 250, through the spout 260 and nozzle 225, to discharge the fluid contained in the container 250 through the nozzle opening 265. Engagement nozzle 225 is preferably cylindrical and smooth, although alternative textures and shapes can be employed that can properly interface with the capless fuel system to unlock and open the fuel system. The length of elongated engagement nozzle 225 is sufficiently long and of a width (e.g. diameter) large enough to disengage a locking mechanism within the throat of the capless fuel system.

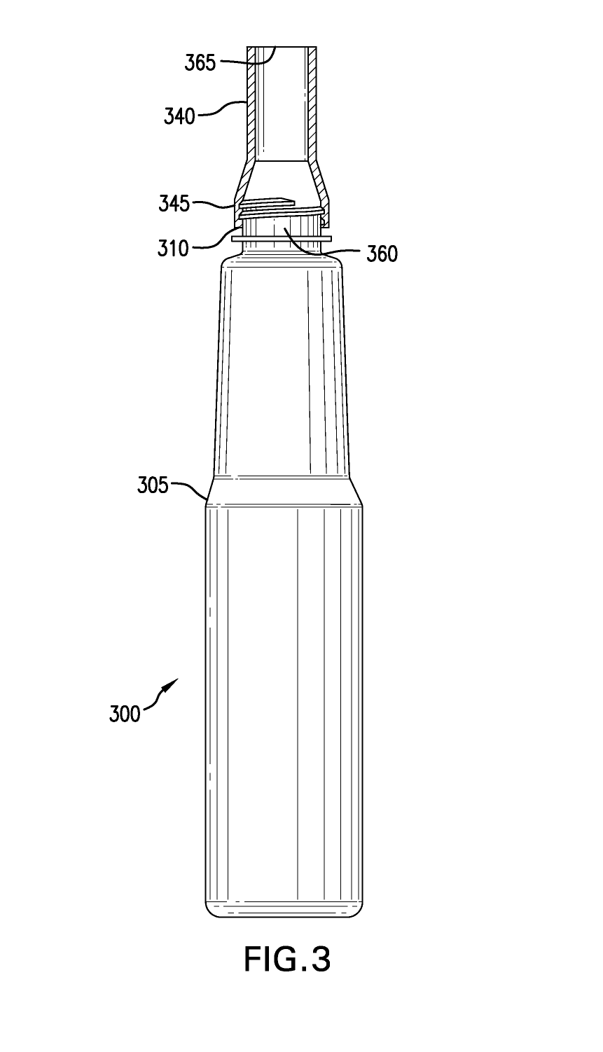

Container 205 is shown having a larger lower portion 257 connected to a tapered upper portion 258 Container 205 can be of any suitable design, shape, or color, and can be customized for different applications or for different customers. Spout 260 can optionally have an axial extension portion 220 that is preferably relatively short and disposed between the container 205 and a cap attachment portion 210. The cap attachment portion 210 of bottle 200 is preferably configured to attach a cap to close the nozzle opening 265. The attachment portion 210 can be disposed on the shortened portion 220, directly on the container 205, or be positioned elsewhere on the spout 250, for example, in a position to remain clear of the outer surface of the engagement nozzle 225 and nozzle opening 265. The cap attachment portion 210 can be threaded, including male, external threads 290 such as when disposed on the container 205 or an a proximal portion of the spout 250 adjacent to the container 205, or between the container 205 and the spout 250, to secure to female internal threads 263 of a cap 270 to close the nozzle opening 265. The attachment portion 210 can have female threads 263 on the interior of the spout 250 to attach to male threads on an exterior of a cap, such an arrangement is shown, for example, in FIG. 3, the bottle 300 of which can alternatively be made of unitary construction instead of having a separate adapter 340. Alternatively, cap attachment portion can provide for other attachment mechanisms, providing, for instance, a snap fit of an interference fit, or other arrangements known in the art. In the embodiment of FIGS. 2A-C, the threads 263 of a cap attachment portion 210 have an outer diameter 280 larger than the outer surface of the engagement nozzle 225. For example, the threads 290 can have a diameter that is typically around 5% to 20% longer than the diameter of the engagement nozzle 225, and preferably around 10% larger. In one embodiment, the threads 290 can have a diameter around 0.85″. The root 295 of the external threads 290 can be sized substantially similar to the outer diameter 280 of elongated engagement nozzle 225. Alternatively, the root 295 of the external threads 290 can be sized larger or smaller than the outer diameter 280 of elongated engagement nozzle 225.

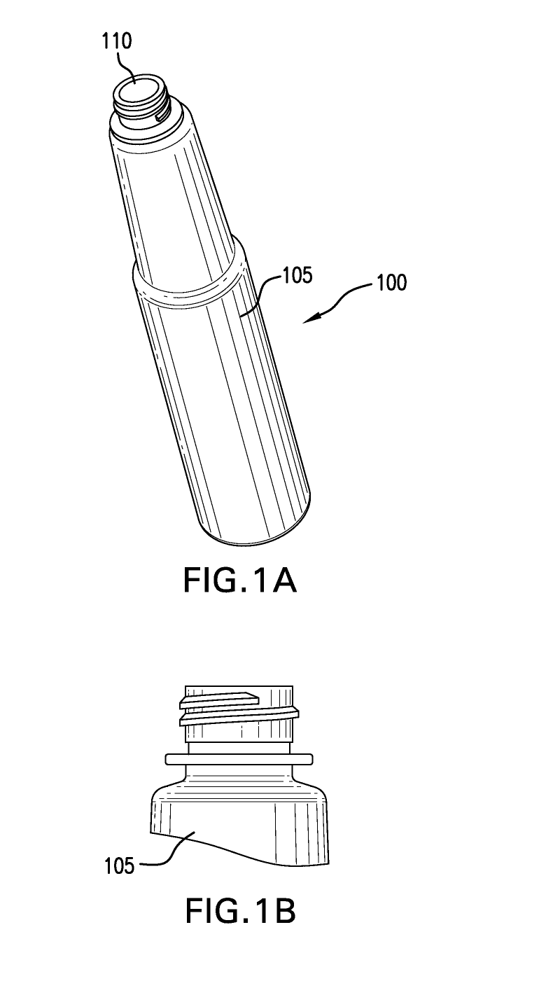

Bottle 200 can have an H value of the spout 260 (the distance from distal end 275 of the spout 260 or engagement nozzle 225, to the base of the spout 260 where the bottle 200 becomes significantly, and preferably suddenly, wider, typically at a step provided by a shoulder 262 at the top of the container 205 or by radial shelf or cap seat such as shown below the threads in FIG. 1B, which can define the base of the spout) of around 1.5″ to 2″, and more or less 1.675″ in one embodiment. However, smaller H values, such as about 1.0″ or larger H values, e.g., about 2.5″ or higher can be used in certain embodiments. Bottle 200 can have an S value (the distance from distal end 275 of the spout 260 or engagement nozzle 225 to the distal end of the cap attachment portion 210, e.g., to the top of the most distal thread of cap attachment portion 210) of between about 0.7″ and 2″. In one embodiment, the S value is about between 1.3 and 1.4, with a target of approximately 1.035″. Smaller S values may be useable for certain types of capless fuel systems, and larger S values are foreseeable as well. For example, the length of the S value can decrease or increase depending on the length necessary to disengage the locking mechanism of the capless fuel system, and the H length can be selected based on the dimensions of the throat of the capless fuel system filler port. Preferably, the S value is equal to or larger than the H value, and preferably more than twice as long or longer., for example at least as long as the length of cap attachment portion 210 (e.g., about 0.65″) can be used. In the exemplary embodiment shown in FIG. 2, the S value corresponds to the entire elongated engagement nozzle 225, as the spout 260 has, for example, a constant diameter distally of the threads of the cap attachment portion 210.

Elongated engagement nozzle 225 can have an outer diameter 280 that is preferably substantially uniform, although other configurations could be used, including slight tapers that are still capable of unlocking and opening a capless fuel system. An exemplary outer diameter is between about 0.6″ to 0.9″, with one embodiment being about 0.8″ or about 0.77″. For a gasoline fuel system, the outer diameter of the engagement nozzle is closely matched to the diameter of a standard gasoline pump nozzle, at about 0.8″. In other embodiments, fuel additive bottle 200 can be used with other fuel systems for other types of fuel, such as diesel, ethanol, a jet fuel, avgas, etc. and preferably has an appropriate diameter and configuration to match the corresponding configurations and dimensional standards of fuel pump nozzle sizes (e.g., about 0.9″ for diesel, about 1.95″ for avgas, about 2.3″ for jet fuel, etc.

In one embodiment, the engagement nozzle 225 has an inner diameter 285 of approximately between 0.5″ and 0.7″, being 0.62″ in one embodiment, although the interior can be varied depending on desired flow characteristics. Additionally, the inner diameter 285 of elongated engagement nozzle 225 can be uniform or tapered or have other shapes. In certain embodiments, the inner diameter 285 is between about 0.7 and 0.9 of the outer diameter 280 of the engagement nozzle 225 although smaller fractions can be used for certain embodiments.

Referring to FIG. 2C, bottle 200 can have a cap 270 that is configured to cover elongated engagement nozzle 225, and cap attachment portion 210, and to create a liquid-tight seal closing off the bottle 200, such as with a seal 274 at the nozzle opening 265 to prevent the release of the liquid inside of fuel additive bottle 200. Cap 270 can have internal thread 263 or other appropriate mechanism configured to engage with the external threads 290 or other mechanism of the cap attachment portion 210. Cap 270 is preferably larger, and optionally close to length of the H value of the bottle, and dimensioned to cover both the elongated engagement nozzle 225 and cap attachment portion 210 in the embodiment shown. The proximal end of cap 270 when attached to the bottle body 200 can terminate at or near the distal end 275 of the container 205 of at a cap seat, or in another location at or proximally beyond the cap attachment portion 210. Cap 270 can also have a tamperproof mechanism such that the user can easily determine if fuel additive bottle 200 has been opened. Additionally, fuel additive bottle 200 and cap 270 can have a child-proof mechanism to prevent a child from accessing the liquid inside, for example requiring the cap to be squeezed or pressed before turning to disengage from the bottle threads 290 or other attachment mechanism. Protrusions 272 or other known mechanisms can be provided on the interior of the cap 270, for example, to interface with the spout 260 or other part of the bottle 200 until released by the appropriate user motion, such as squeezing the sides of the cap 270.

To engage with a capless fuel system, a portion of the elongated engagement nozzle 225, such as the tip 275 or outer surface of the engagement nozzle 225 for example, can be configured to depress at least one disengagement element 515 of a capless fuel system 500, which is typically located at the side of the entrance to the capless filler system, upstream of the door.

Fuel additive bottle 200 can be a single use bottle containing sufficient volume for a single application of fuel additive or other liquid, such that a user of the bottle 200 purchases a bottle for one-time use and discards the bottle thereafter. Alternatively, the bottle 200 can have sufficient volume for multiple uses, or and can be refilled after some or all liquid inside of fuel additive bottle 200 has been used. Bottle 200 can be formed with the container 250 and nozzle 260, and preferably the cap attachment portion 210 of unitary construction, although in some embodiments, some or each other these parts can be constructed from separate, assembled parts.

In a further exemplary embodiment, as depicted in FIG. 3, a traditional bottle 300 can be modified to for use in a capless fuel system to provide the bottle 300 with an engagement nozzle and cap attachment portion as described with reference to FIGS. 2A-C. Bottle 300 can include a container 305 designed to hold a liquid (e.g., a fuel additive), and a traditional cap engagement portion 360 on a short spout. Container 305 is shown having a larger lower portion connected to a tapered upper portion. However, container 305 can be of any design, shape, or color, and can be customized for different applications or for different customers.

Fuel additive bottle 300 can have a traditional cap configured to engage threads 310 or other mechanism or cap engagement portion 360 and cover the spout opening to close and seal the bottle. Additionally, fuel additive bottle 300 can be a single use bottle such that a user of the fuel additive bottle 300 purchases a bottle for one-time use, and discards the bottle after the single use, or fuel additive bottle 300 can be designed for multi-use, and can be refilled after some or all liquid inside of fuel additive bottle 300 has been used.

When used with a capped fuel system, the cap can be removed from fuel additive bottle 300 and the liquid inside of fuel additive bottle 300 is poured into the fuel tank. When fuel additive bottle 300 is used with a capless fuel system, an adaptor 340 can be used. Adaptor 340 can have an elongated engagement nozzle to disengage the locking mechanism of a capless fuel system, and can have characteristics similar to elongated engagement nozzle 225 of the previously described embodiment. Adaptor 340 can have internal threads 345 or other attachment mechanism corresponding to the attachment portion 360 mechanism to engage threaded portion 310 and attach to the container 305. The user can insert the bottle with the adapter 340 into the capless fuel system to add the fuel additive as described below.

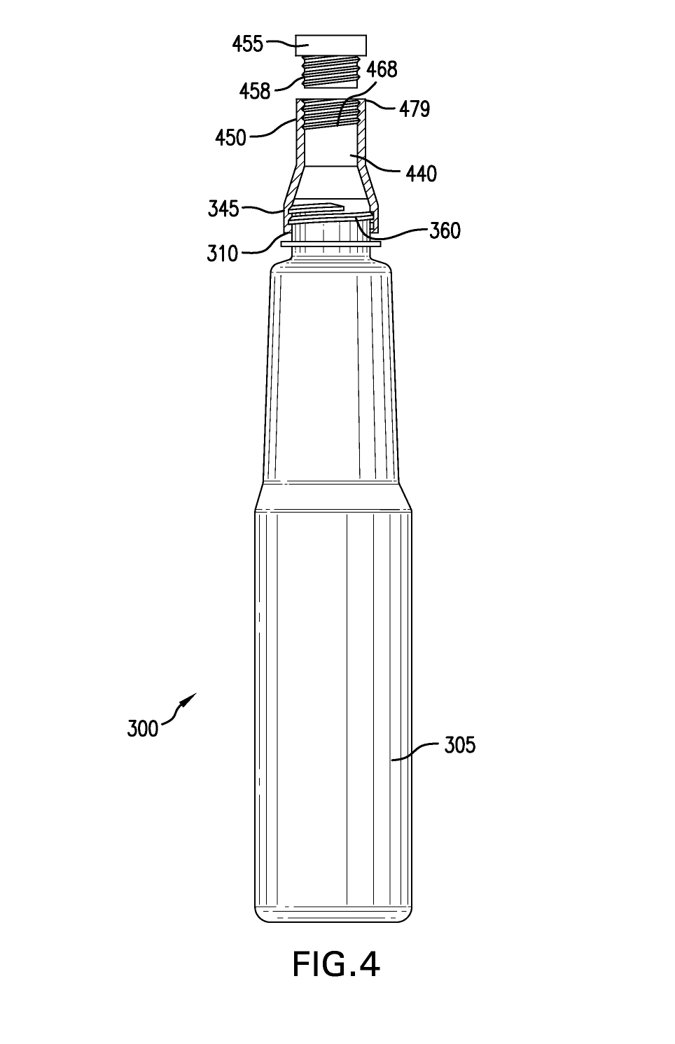

In a further exemplary embodiment, as depicted in FIG. 4, adaptor 340 may optionally be sold or provided to the user already attached to bottle 300, without the need for the user to attach the adaptor 340, as the adapter provides a seal for the liquid in the container 305. Adaptor 340 can be prepackaged already attached to fuel additive bottle 300 using internal threads 345 or another attachment mechanism, as described with respect to FIG. 3. Adaptor 440 can have second internal threads 450 within the interior of the conduit 468, such as near the distal end of the engagement nozzle 375, which are configured to engage with cap 455 (e.g., using external threads 458 of cap 455). In another embodiment, the cap threads or other attachment mechanism can be provided externally on the adapter 440 near the proximal end thereof to achieve a configuration similar to, and using a cap similar to, that shown in FIGS. 2A-C. To add a fuel additive to a capless fuel system, the user removes cap 455 and insert adaptor 340 into the capless fuel system.

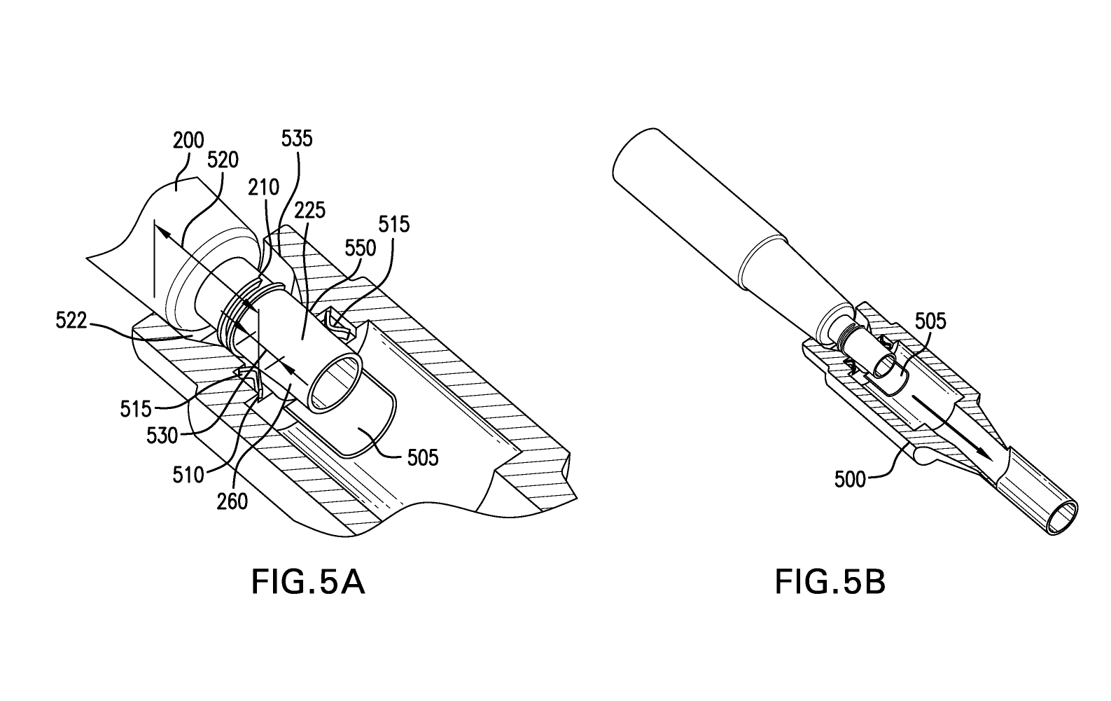

Referring to FIGS. 5A and 5B, capless fuel system 500, such as the Ford capless fuel system known in the art, can have a fuel door 505 that covers and closes the fuel system filler port. Door 505 can be spring loaded or otherwise biased towards a closed position, and can be locked in place by a door release locking mechanism 510. Locking mechanism 510 can include a plurality of disengagement elements, such as tabs 515, such that locking mechanism 510 does not disengage unless all of the plurality of tabs 515 are engaged (although it is foreseen that the locking mechanism could be configured to unlock if less than all of the tabs are engaged). For example, when tabs 515 are depressed radially outwardly, door 505 can be unlocked and moved into an open position by elongated engagement nozzle 225. Alternatively, the depression of tabs 515 can cause door 505 to be moved into an open position automatically in some embodiments, optionally allowing elongated engagement nozzle 225 to enter further into capless fuel system 500, and allowing the nozzle opening 265 to dispense the liquid from the container 200. When the engagement nozzle 225 is removed from the filler port of the fuel system, tabs 515 are released, and the door 505 is closed and locking mechanism 510 relocks the door 505.

When the spout 260 is inserted into the throat 522 of the capless fuel system 500 that leads to a fuel tank, such as of a car, motorcycle, or other motor vehicle, the treads 290 or other cap attachment portion 210 can remain clear of the tabs 515 or other disengagement element. For example, the cap attachment portion 210 shown in FIGS. 2 and 2B remain outside, or less deep, than the depth of the tabs 515, or a cap attachment portion 210 would remain clear of the tabs 515 as it is internal to the engagement nozzle 225.

The throat 522 of the capless fuel system 500 can include an outer mouth portion 535 at the outermost part of capless fuel system 500 filler port. The mouth portion 535 can be substantially cylindrical or can be tapered, for example and include a tapering area 540. The tapering area narrows into the capless fuel system 500, preferable to slightly larger than the standard size fuel nozzle corresponding to the type of fuel for which the fuel system is intended to be used, preferably reaching that diameter just outside of the disengagement elements, such as tabs 515. The mouth 535 depth 520 of approximately 0.5″ to 1″, but can be shallower or deeper in other embodiments. Additionally, the depth 530 of the tabs 515 or other disengagement element beyond where the fuel system filler port has narrowed is about 0.2″ to 1″, and the S value of the engagement nozzle 225 should be sufficiently long to engage and operate the tabs 515 or other disengagement mechanism, and preferably also push open the fuel door 505, which is shown as an exemplary flap in an open position in FIGS. 5A and 5B. As shown, the H value and the outer diameter of the threads or other attachment portion 210 is preferably selected so that the proximal base of the spout 260 is received within the fuel system mouth 535, with the container remaining outside the fuel system during emptying the bottle 200 into the system.

To use fuel additive bottle 200 with capless fuel system 500, the elongated engagement nozzle 225 is inserted into an opening in capless fuel system 500. The elongated engagement nozzle 225 contacts and depresses the plurality of tabs 515, disengaging locking mechanism 510, with cap attachment portion 210 not reaching or otherwise remaining clear of the tabs 515. Once the locking mechanism 510 has been disengaged, fuel additive bottle 200 can optionally be inserted further into the fuel system, displacing door 505. The liquid contained inside of bottle 200 can then be poured into the fuel system. When bottle 200 is removed, door 505 is biased back into a closed position, and tabs 515 are released, which can reengage locking mechanism 510.

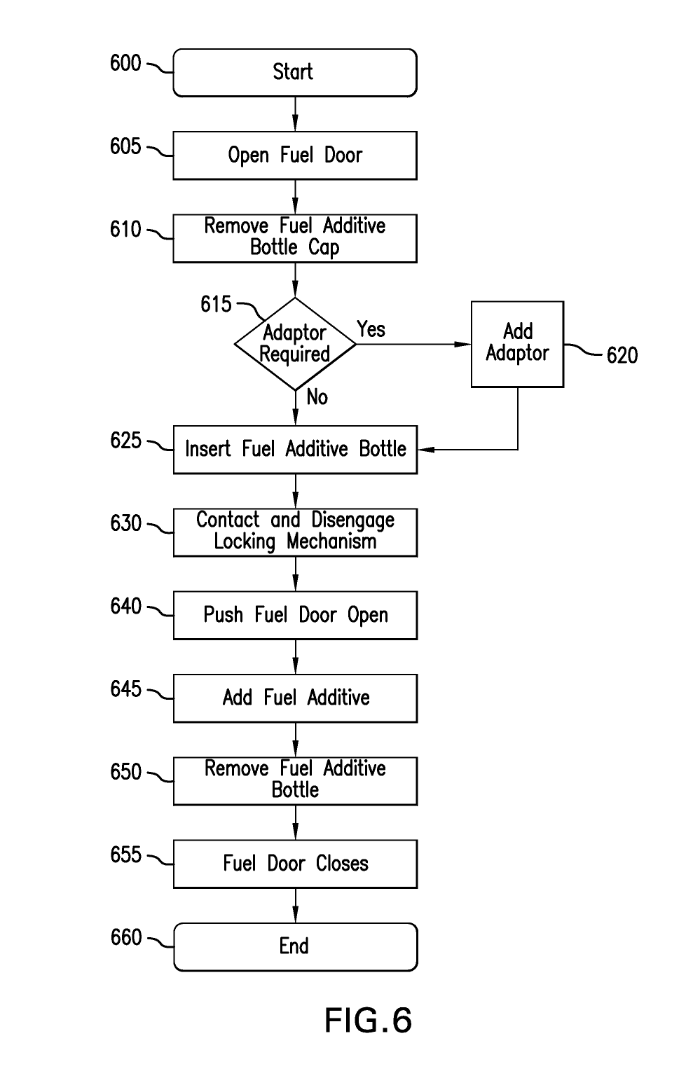

As depicted in FIG. 6, a method of adding a fuel additive to a capless fuel system is shown. In an embodiment of the method, the fuel additive is chosen at step 600. At step 605, the user opens an optional external fuel door covering the capless fuel system. For example, if a user is adding a fuel additive to a car, the user releases the fuel door on the side of the car that covers the fuel system. At step 610, the user removes the cap from the fuel additive bottle. If an adaptor is required, the user attaches an adaptor to the spout of the fuel additive bottle at step 620, and the user inserts the end of the fuel additive bottle with the adaptor attached into the capless fuel system at step 625. If an adaptor is not required, the user proceeds directly to step 625 and inserts the spout of the fuel additive bottle into the capless fuel system.

When the spout 260, either with or without an adaptor, is inserted into the capless fuel system, the engagement nozzle 225 contacts and disengages the locking mechanism at step 630. At step 640, the engagement nozzle 225 is inserted further into the capless fuel system, past the tabs 515, and contacts and moves the door 505 covering the capless fuel system. At step 645, the fuel additive is added into the capless fuel system. At step 650, the fuel additive bottle is removed, allowing the door to move back into a covering position, reengaging the locking mechanism. At step 655 the fuel door is closed, and the method ends at step 660.

In the above exemplary embodiments a threaded portion is incorporated in order to secure a cap to the fuel additive bottle, as well as to secure an adaptor to the fuel additive bottle. However, it should be noted, that other suitable types of engagement or securing mechanism can be used to secure a cap to the fuel additive bottle or to secure the adaptor to the fuel additive bottle.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety.

What is claimed is:

1. A method for adding a liquid to a capless fuel system, comprising:
providing a bottle comprising:
a container holding the liquid,
a spout extending from and in fluid communication with the container and including an elongated engagement nozzle having a radially outer surface extending to a distal tip of the bottle, the nozzle defining an opening for discharging the fluid from the bottle, and
a cap attachment portion configured for attaching a cap to close the engagement nozzle opening, the cap attachment portion disposed clear of an outer surface of the engagement nozzle; and
inserting the engagement nozzle into a throat of a capless fuel system sufficiently far to contact and operate a lock disengagement element within the throat to open an internal closure within the throat.

2. The method of claim 1, wherein the cap attachment portion is disposed on the bottle so as to remain clear of contact with the lock disengagement element as the elongated engagement nozzle is inserted into the throat.

3. The method of claim 1, wherein the cap attachment portion is disposed proximally of the engagement nozzle, such that the engagement nozzle operates the lock disengagement element upon insertion of the engagement nozzle into the throat without the cap attachment portion reaching the lock disengagement element.

4. The method of claim 1, wherein the cap attachment portion is disposed proximally of the engagement nozzle to remain proximal of the lock disengagement element when the engagement nozzle inserted into the throat operated the lock disengagement element.

5. The method of claim 4, wherein the attachment portion is disposed on the spout between the engagement nozzle and the container.

6. The method of claim 5, wherein the throat includes an outer mouth portion that tapers towards the lock disengagement element, the attachment portion being inserted into the mouth when the engagement nozzle operates the lock disengagement element.

7. The method of claim 4, wherein the cap attachment portion comprises male threads configured to engage female threads of a cap.

8. The method of claim 7, wherein the elongated engagement nozzle is axially longer than the cap attachment portion.

9. The method of claim 4, wherein the cap attachment portion is less than half the axial length and is larger in outer diameter than the engagement nozzle.

10. The method of claim 1, wherein the cap attachment portion is disposed within the bottle to attach to a counterpart engagement portion of a cap.

11. The method of claim 10, wherein the cap attachment portion comprises female threads on an interior surface of the engagement nozzle configured to engage male threads of a cap.

12. The method of claim 1, wherein the bottle is provided with the cap attached to the cap attachment portion and closing the opening, the method further comprising detaching the cap from the cap attachment portion to open the opening.

13. The method of claim 1, wherein the disengagement element comprises a tab that is depressed radially by the engagement nozzle inserted into the throat.

14. The method of claim 1, further comprising dispensing the liquid from the bottle into the open capless fuel system.

15. The method of claim 1, wherein the bottle is of unitary construction.

16. The method of claim 1, wherein the liquid is a fuel additive.

17. The method of claim 1, wherein the outer surface of the engagement nozzle is substantially cylindrical.

18. The method of claim 17, wherein the outer surface of the engagement nozzle has a diameter of around 0.8 inches.

19. A method for adding a liquid to a capless fuel system, comprising:
providing a bottle comprising:
a bottle portion holding the liquid;
a neck portion extending from and in fluid communication with the bottle portion and including an elongated portion and a threaded portion configured for attaching a cap to close the elongated portion, the threaded portion disposed clear of a surface of the elongated portion;
wherein the elongated portion is axially longer than the threaded portion, and has a radially outer surface extending to an end of the bottle, the neck portion defining an opening for discharging the fluid from the bottle; and
inserting the elongated portion into a capless fuel system sufficiently far to contact and operate a locking mechanism within the capless fuel system to open a door within the capless fuel system.

20. A fuel additive bottle useable with a capless fuel system, the bottle comprising:
a container;
a fuel additive contained in the container;
a spout extending from and in fluid communication with the container and including an elongated engagement nozzle having a radially outer surface extending to a distal tip of the bottle, the engagement nozzle defining an opening for discharging the fluid from the bottle and having an axial length and radial diameter dimensioned for insertion into the throat of a capless fuel system sufficiently far to contact and operate a lock disengagement element within the throat and to open an internal closure within the throat; and
a cap attachment portion configured for attaching a cap to close the engagement nozzle opening, the cap attachment portion disposed clear of an outer surface of the engagement nozzle.

21. The fuel additive bottle of claim 20, wherein the elongated engagement is axially longer than the cap attachment portion.

22. The fuel additive bottle of claim 20, wherein the cap attachment portion is less than half the axial length and is larger in outer diameter than the engagement nozzle.

23. The fuel additive bottle of claim 20, wherein the engagement nozzle has a length of around 1 inch.

24. The fuel additive bottle of claim 20, wherein the outer surface of the engagement nozzle has a diameter of around 0.8 inches.

25. The fuel additive bottle of claim 20, wherein the attachment portion is disposed between the engagement nozzle and the container.

26. The fuel additive of claim 20, wherein the bottle is of unitary construction.
